(19) United States
(12) Patent Application Publication
(10) Pub. No.: US 2024/0210554 A1
(43) Pub. Date: Jun. 27, 2024

(54) OBJECT DETECTION USING CONVOLUTION NEURAL NETWORKS WITH SPATIALLY INVARIANT REFLECTIVE-INTENSITY DATA

(71) Applicant: GM GLOBAL TECHNOLOGY OPERATIONS LLC, Detroit, MI (US)

(72) Inventors: Oded Bialer, Petah Tikva (IL); Yuval Haitman, Oranit (IL)

(73) Assignee: GM GLOBAL TECHNOLOGY OPERATIONS LLC, Detroit, MI (US)

(21) Appl. No.: 18/086,158

(22) Filed: Dec. 21, 2022

(51) Int. Cl. G01S 13/931; G01S 7/41; G01S 13/58

(52) U.S. Cl. CPC G01S 13/931; G01S 7/417; G01S 13/58

(57) ABSTRACT

A method that includes obtaining reflective radar signals regarding a scene monitored by a radar sensor system, producing reflective-intensity (RI) data based on those signals, and generating a reflective intensity volume (RIV) based on the reflective-intensity data. The RI data contains spatially invariant spectrums. The method further includes applying a trained convolutional neural network (CNN) on the generated RIV and detecting objects in the scene based, at least in part, the applying of the trained CNN on the generated RIV.

### INTRODUCTION

This disclosure relates to techniques for radar signal optimization for convolution neural networks.

Automotive radar is the most promising and fastest-growing civilian application of radar technology. Vehicular radars provide the key enabling technology for the autonomous driving revolution that has the potential to improve everyone's day-to-day lives. Automotive radars, along with other sensors such as lidar, (which stands for “light detection and ranging”), ultrasound, and cameras, form the backbone of self-driving cars and advanced driver assistant systems (ADASs). These technological advancements are enabled by extremely complex systems with a long signal processing path from radars/sensors to the controller. Automotive radar systems are responsible for the detection of objects and obstacles, their position, and speed relative to the vehicle

### SUMMARY

According to one embodiment, a method that facilitates object detection includes 1) obtaining reflective radar signals regarding a scene monitored, the reflective radar signals being received by multiple antennas of a radar sensor system; 2) producing reflective-intensity data based on the reflective radar signals, the reflective-intensity data containing multiple spatially invariant spectrums; 3) generating a reflective intensity volume (RIV) based on the reflective-intensity data; 4) applying a trained convolutional neural network (CNN) on the generated RIV; and 5) detecting objects in the scene based, at least in part, the applying of the trained CNN on the generated RIV.

In this embodiment, the method may further include 1) reporting detected objects to a perception system of a vehicle; and 2) classifying the detected objects in the scene.

With this embodiment of the method, the spatially invariant spectrums of the reflective-intensity data include 1) a range reflective-intensity spectrum includes relative distances between reflection points indicated by the reflective-intensity data and the radar sensor system, 2) a speed (“Doppler”) reflective-intensity spectrum includes speeds of the reflection points indicated by the reflective-intensity data relative to the radar sensor system, and 3) an adjusted azimuth (“adjusted-azimuth”) spectrum, which is based on azimuths of the reflection points indicated by the reflective-intensity data relative to the radar sensor system.

With this embodiment, the producing reflective-intensity data includes determining a two-dimensional range-Doppler transform that incorporates the range reflective-intensity spectrum and Doppler reflective-intensity spectrum.

In this embodiment of the method, the determining the two-dimensional range-Doppler transform includes: 1) transforming the range reflective-intensity spectrum by the reflective radar signals, wherein the range reflective-intensity spectrum includes range bins based on the reflective radar signals by multiple antennas of the radar sensor system; and 2) transforming the Doppler reflective-intensity spectrum by the reflective radar signals, wherein the Doppler reflective-intensity spectrum includes Doppler bins based on the range bins and the reflective radar signals by multiple antennas of the radar sensor system.

In this embodiment, the producing reflective-intensity data includes determining the adjusted-azimuth spectrum by calculating sine of the azimuth (“sin(azimuth)”) relative to a two-dimensional range-Doppler transform that incorporates the range reflective-intensity spectrum and Doppler reflective-intensity spectrum.

In this embodiment, the producing reflective-intensity data includes determining the adjusted-azimuth spectrum by calculating sine of the azimuth (“sin(azimuth)”) relative to the range bins and Doppler bins of the two-dimensional range-Doppler transform; and the generating includes combining results of the calculating for the range bins and Doppler to produce a three-dimensional, spatially invariant range-speed-adjusted-azimuth transform.

In this embodiment, wherein each antenna of the multiple antennas having has a distance relative to other antennas of the multiple antennas and employing a radar signal having a defined wavelength, and the calculating of the adjusted-azimuth spectrum includes performing Equation 1 herein.

In this embodiment of the method, the applying includes converting the three-dimensional, spatially invariant range-speed-adjusted-azimuth transform into a three-dimensional, spatially variant range-speed-azimuth transform by performing inverse sine operation in the azimuth spectrum.

In this embodiment of the method, the RIV includes reflection points and has matching spreading functions associated with each reflection point.

Other embodiments include device selected from a group consisting of an autonomous or semi-autonomous vehicle, a video surveillance system, a medical imaging system, a video or image editing system, an object tracking system, a video or image search or retrieval system, and a weather forecasting system, the device being configured to perform the above-mentioned method.

According to yet another embodiment, a method includes 1) obtaining reflective radar signals regarding a scene monitored, the reflective radar signals being received by multiple antennas of a radar sensor system; 2) producing reflective-intensity data based on the reflective radar signals, the reflective-intensity data containing multiple spatially invariant spectrums, which include a range reflective-intensity spectrum includes relative distances between reflection points indicated by the reflective-intensity data and the radar sensor system, a speed (“Doppler”) reflective-intensity spectrum includes speeds of the reflection points indicated by the reflective-intensity data relative to the radar sensor system, and an adjusted azimuth (“adjusted-azimuth”) spectrum, which is based on azimuths of the reflection points indicated by the reflective-intensity data relative to the radar sensor system, and wherein the producing includes determining a two-dimensional range-Doppler transform that incorporates the range reflective-intensity spectrum and Doppler reflective-intensity spectrum; 3) generating a reflective intensity volume (RIV) based on the reflective-intensity data; 4) applying a trained convolutional neural network (CNN) on the generated RIV; and 5) detecting objects in the scene based, at least in part, the applying of the trained CNN on the generated RIV.

In this embodiment, determining the two-dimensional range-Doppler transform includes transforming the range reflective-intensity spectrum by the reflective radar signals, wherein the range reflective-intensity spectrum includes range bins based on the reflective radar signals by multiple antennas of the radar sensor system; and transforming the Doppler reflective-intensity spectrum by the reflective radar signals, wherein the Doppler reflective-intensity spectrum includes Doppler bins based on the range bins and the reflective radar signals by multiple antennas of the radar sensor system.

With this embodiment, the producing reflective-intensity data includes determining the adjusted-azimuth spectrum by calculating sine of the azimuth (“sin(azimuth)”) relative to a two-dimensional range-Doppler transform that incorporates the range reflective-intensity spectrum and Doppler reflective-intensity spectrum.

In this embodiment of the method, the producing reflective-intensity data includes determining the adjusted-azimuth spectrum by calculating sine of the azimuth (“sin(azimuth)”) relative to the range bins and Doppler bins of the two-dimensional range-Doppler transform; and the generating includes combining results of the calculating for the range bins and Doppler to produce a three-dimensional, spatially invariant range-speed-adjusted-azimuth transform.

In this embodiment, the applying includes converting the three-dimensional, spatially invariant range-speed-adjusted-azimuth transform into a three-dimensional, spatially variant range-speed-azimuth transform by performing inverse sine operation in the azimuth spectrum.

According to yet another embodiment, a non-transitory machine-readable storage medium encoded with instructions executable by one or more processors that, when executed, direct the one or more processors to perform operations that facilitate object detection. These operations include 1) obtaining reflective radar signals regarding a scene monitored, the reflective radar signals being received by multiple antennas of a radar sensor system; 2) producing reflective-intensity data based on the reflective radar signals, the reflective-intensity data containing multiple spatially invariant spectrums, which include a range reflective-intensity spectrum includes relative distances between reflection points indicated by the reflective-intensity data and the radar sensor system, a speed (“Doppler”) reflective-intensity spectrum includes speeds of the reflection points indicated by the reflective-intensity data relative to the radar sensor system, and an adjusted azimuth (“adjusted-azimuth”) spectrum, which is based on azimuths of the reflection points indicated by the reflective-intensity data relative to the radar sensor system, and wherein the producing includes determining a two-dimensional range-Doppler transform that incorporates the range reflective-intensity spectrum and Doppler reflective-intensity spectrum; 3) generating a reflective intensity volume (RIV) based on the reflective-intensity data; 4) applying a trained convolutional neural network (CNN) on the generated RIV; and 5) detecting objects in the scene based, at least in part, the applying of the trained CNN on the generated RIV.

The non-transitory machine-readable storage medium embodiment in which the determining the two-dimensional range-Doppler transform includes transforming the range reflective-intensity spectrum by the reflective radar signals, wherein the range reflective-intensity spectrum includes range bins based on the reflective radar signals by multiple antennas of the radar sensor system; and transforming the Doppler reflective-intensity spectrum by the reflective radar signals, wherein the Doppler reflective-intensity spectrum includes Doppler bins based on the range bins and the reflective radar signals by multiple antennas of the radar sensor system.

The non-transitory machine-readable storage medium embodiment in which the producing reflective-intensity data includes determining the adjusted-azimuth spectrum by calculating sine of the azimuth (“sin(azimuth)”) relative to a two-dimensional range-Doppler transform that incorporates the range reflective-intensity spectrum and Doppler reflective-intensity spectrum.

The non-transitory machine-readable storage medium embodiment in which the producing reflective-intensity data includes determining the adjusted-azimuth spectrum by calculating sine of the azimuth (“sin(azimuth)”) relative to the range bins and Doppler bins of the two-dimensional range-Doppler transform; and the generating includes combining results of the calculating for the range bins and Doppler to produce a three-dimensional, spatially invariant range-speed-adjusted-azimuth transform.

The above features and advantages, and other features and advantages of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 illustrates an example scenario that illustrates the capture of an azimuth spectrum of a reflective intensity volume (RIV), in accordance with one or more implementations described herein.

FIG. 2 illustrates an example of computer architecture for a computing system capable of executing the technology described herein.

FIG. 3 is a flowchart illustrating a process to perform an example method of object detection, in accordance with one or more implementations described herein.

### DETAILED DESCRIPTION

The technology described herein facilitates object detection using a spatially invariant convolutional neural network (CNN) system based on a radar reflective intensity volume (RIV) that depicts reflection points that are processed so that their associated data is spatially invariant.

Referring now to the drawings, wherein like numerals indicate like parts in the several views of various systems and approaches are shown and described herein. Disclosed approaches may be suitable for autonomous driving, but may also be used for other applications, such as robotics, video analysis, weather forecasting, medical imaging, etc.

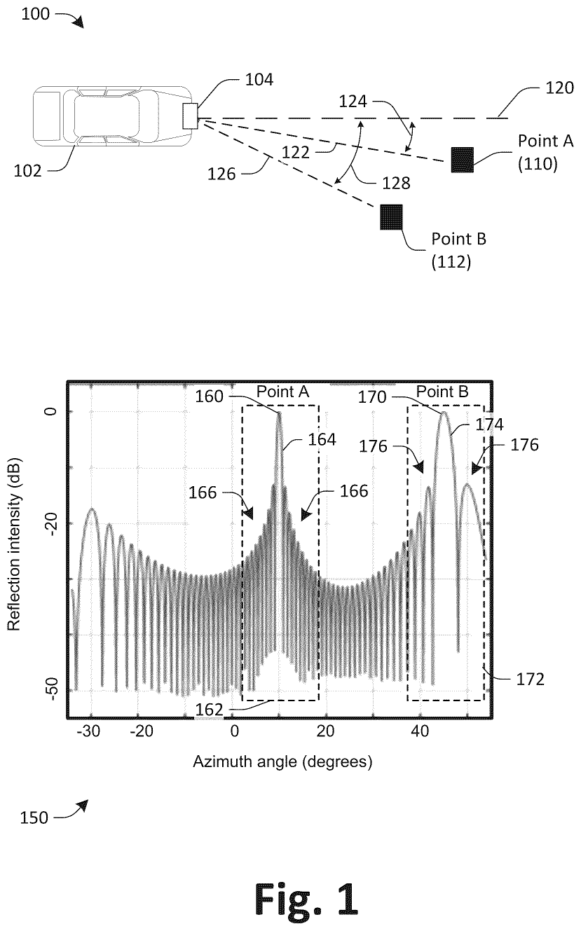

The present disclosure may be described with respect to an example vehicle 102, which is described in more detail herein with respect to FIG. 1. Although the present disclosure primarily provides examples using automobiles, other types of devices may be used to implement those various approaches described herein, such as robots, camera systems, weather forecasting devices, medical imaging devices, etc. In addition, these approaches may be used for controlling autonomous vehicles, or for other purposes, such as, without limitation, video surveillance, video or image editing, video or image search or retrieval, object tracking, weather forecasting, and/or medical imaging (e.g., using ultrasound or magnetic resonance imaging (MRI) data).

Vehicles often have radar systems to detect and avoid nearby cars, obstacles, and other objects. Automotive radar systems are used to detect the relative location and speed of objects in the vicinity of a vehicle. Such systems typically include a radar sensor system, that includes a transmitter and receiver. The transmitter sends out radio waves that hit an object and bounce back to the receiver. This bounce back is called a reflection. The radar system determines properties of a reflection to help determine an object's location and speed relative to the vehicle.

More particularly, the radar system may create a reflective intensity volume (RIV). The RIV maps out the reflection intensity across three spectrums of the measured properties of the received reflections: range, speed (“Doppler”), and azimuth. Thus, the RIV may be considered a three-dimensional cube of reflection intensity data in the categories of range, Doppler, and azimuth.

The reflective intensity of a range reflective-intensity spectrum indicates the relative distance between the vehicle and a reflection point, which may be an object. That is, the range is the one-dimensional distance between vehicle and a reflection point.

The reflective intensity of a Doppler reflective-intensity spectrum indicates the relative speed and/or direction of travel of a reflection point, which may be an object. This is accomplished utilizing the familiar Doppler effect or shift. That is, the change in the received signal frequency due to the movement of the reflected object relative to the vehicle. Herein, unless the context indicates otherwise, the term “speed” or “Doppler” refers to the spectrum of the relative speed and/or direction of travel of the reflection. In addition, Doppler may include the radial component of the velocity vector of the reflection point as well. The radial component is the projection of the velocity vector on the direction between the reflection point and the radar sensor system.

The reflective intensity of an azimuth spectrum indicates the azimuth angle measurement between the vehicle and a reflection point, which may be an object. Herein, unless the context indicates otherwise, the term “azimuth” refers to a spectrum of the relative angles of the reflection point and the radar sensor system.

An automotive radar system typically has multiple transmit and receive channels. The different transmit channels are used to drive different antennas. These multiple transmit channels also provide beam steering capabilities. Multiple receive channels give the angular information about the object as there is phase difference between signals received by different receive antennas.

FIG. 1 illustrates an example scenario 100 that illustrates the capture of the azimuth spectrum of a RIV. The example scenario 100 includes a vehicle 102, which is an automobile with a radar sensor system 104 for object detection purposes. In this example scenario 100, there are two reflection points: Point A 110 and point B 112. These reflection points indicate a potential object in the scene of the radar sensor system 104. The scene is the area or volume scanned by the radar sensor system 104.

Dashed line 120 indicates the baseline or zero-degree line for the radar sensor system 104. Dashed line 122 is the straight line from the radar sensor system 104 and Point A 110. The angle between dashed lines 120 and 122 is an azimuth 124, which may be called theta 1 (θ₁) of Point A. That is, the angle measurement between the radar sensor system 104 and the Point A 110 is the azimuth theta 1 (θ₁).

Similarly, dashed line 126 is the straight line from the radar sensor system 104 and Point B 112. The angle between dashed lines 120 and 126 is an azimuth 128, which may be called theta 2 (θ₂) of Point B. That is, the angle measurement between the radar sensor system 104 and Point B 112 is the azimuth theta 2 (θ₂).

FIG. 1 also includes a reflection-intensity-azimuth chart 150 with the Y-axis representing the reflection intensity and the X-axis representing the azimuth of that reflected intensity. This chart simply depicts a portion of the RIV, namely the azimuth domain. The Doppler and range domains of the RIV are not shown in chart 150.

In chart 150, the top two reflective intensities are represented by reflection peaks 160 and 170. The reflection peak 160 is at approximately ten degrees azimuth angle. The reflection peak 170 is at approximately forty-five degrees azimuth angle.

Area 162 around the peak 160 includes a main lobe 164 at the center with side lobes 166 cascading symmetrically therefrom in opposing directions. Similarly, area 172 around the peak 170 includes a main lobe 174 at the center with side lobes 176 cascading symmetrically therefrom in opposing directions.

The side lobes are artifacts of the real reflection peak and do not represent actual reflections. For example, side lobes 166 are artifacts of the real reflection of point A 110, which is represented at peak 160 of the main lobe 164. The phenomenon that produces these artifacts maybe called “blurring,” “spreading function,” or a “point spread function” (PSF) herein. The PSF may describe the response of a focused imaging system to a point source or point object.

The PSF may be thought of as an impulse response of the radar sensor system. The PSF in many contexts can be considered the extended blob or blurring in an image that represents a single point object, considered a spatial impulse. It is a useful concept in Fourier optics, astronomical imaging, radar, medical imaging, electron microscopy and other imaging techniques such as microscopy and fluorescence microscopy.

Thus, the side lobes are PSF of the real reflection peak and do not represent actual reflections. For example, the side lobes 166 are PSF of the real reflection of point A 110, which is represented at peak 160 of the main lobe 164. Also, the side lobes 176 are PSF of the real reflection of point B 112, which is represented at peak 170 of the main lobe 174.

As depicted in chart 150, the spreading functions (e.g., side lobes) of each peak differ from each other in their appearance (e.g., differing patterns). Indeed, the spreading functions of peaks vary by their azimuth. For example, the side lobes 166 (i.e., spreading function) of the peak 160 at ten degrees azimuth varies from the side lobes 176 (i.e., spreading function) of the peak 170 at forty-five degrees azimuth. Within the context of the azimuth spectrum, the spreading functions are described as being spatially variant.

This partially has hindered the use of neural networks, machine learning, and other artificial intelligence (AI) techniques that may be used for object detection based on the RIV provided by a radar sensor system. The pattern of a peak and its spreading function varies along the azimuth spectrum. This spatial variation muddles the pattern-recognition capabilities of networks, machine learning, and other artificial intelligence (AI) systems.

This issue is particularly acute with convolutional neural network (CNN) systems. CNNs are a specialized type of artificial neural network that uses a mathematical operation called convolution in place of general matrix multiplication in at least one of their layers. They are specifically designed to process pixel data and are often employed in image recognition and processing.

By their nature, CNNs presume spatial invariance. Indeed, some call CNNs Shift Invariant or Space Invariant Artificial Neural Networks (SIANN). This is because CNNs employ a shared-weight architecture of the convolution kernels (i.e., filters) that slide along input features and provide translation-equivariant responses, which may be represented as feature maps.

CNNs are regularized versions of multilayer perceptrons. Multilayer perceptrons usually mean fully connected networks, that is, each neuron in one layer is connected to the neurons in the next layer. The “full connectivity” of these networks makes them prone to overfitting data. In response, the CNNs perform regularization (i.e., preventing overfitting) by taking advantage of the hierarchical pattern in data and assemble patterns of increasing complexity using smaller and simpler patterns embossed in their filters.

CNNs use relatively little pre-processing compared to other image classification approaches. This means that the CNN learns to optimize the filters (i.e., kernels) through automated learning, whereas in traditional AI approaches, these filters are hand-engineered. Thus, CNNs have independence from prior knowledge and human intervention in feature extraction.

Thus, the technology described herein facilitates object detection using a spatially invariant CNN system based on a radar RIV that depicts reflection points that are spatially variant. The technology modifies the RIV so that the depicted reflection points are spatially invariant and, thus, fitting for the spatially invariant CNN system.

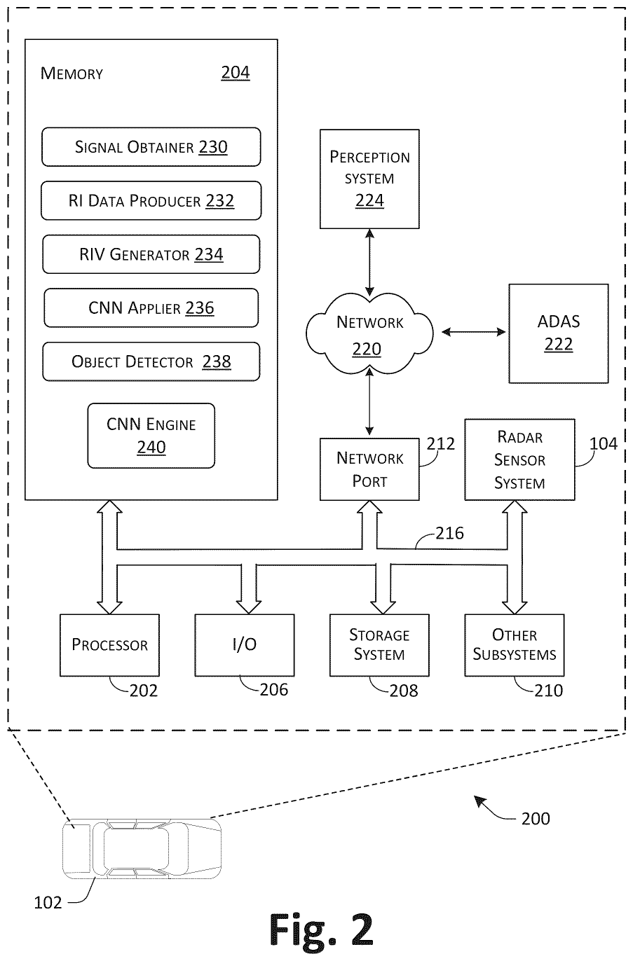

FIG. 2 illustrates an example of computer architecture for a computing system 200 capable of executing the technology described herein. The computer architecture shown in this figure illustrates a typical computer, server computer, workstation, desktop computer, laptop, tablet, network appliance, e-reader, smartphone, or another computing device. The computer system 200 may be part of vehicle 102 and can be utilized to execute the functionalities presented herein.

The computing system 200 includes a processor 202 (e.g., central processor unit or “CPU”), a system storage (e.g., memory) 204, input/output (I/O) devices 206—such as a display, a keyboard, a mouse, and associated controllers, a secondary storage system 208 (e.g., a hard drive), and various other subsystems 210. In various embodiments, the computing system 200 also includes network port 212 operable to connect to a network 220, which is likewise accessible by an advanced driver assistant system (ADAS) 222 and perception system 224. The computing system 200 may include or be connected to the radar sensor system 104. The foregoing components may be interconnected via one or more buses 216 and/or the network 220.

System memory 204 may store data and machine-readable instructions (e.g., computer-readable instructions). The computing system 200 may be configured by machine-readable instructions. Machine-readable instructions may include one or more instruction modules. The instruction modules may include computer program modules. The instruction modules may include one or more of a signal obtainer module 230, a reflective-intensity (RI) data producer module 232, an RIV generator module 234, a CNN applier module 236, an object detector module 238, a CNN engine 240, and/or other instruction-based modules.

The radar sensor system 104 may include a transmitter, receiver, and an array of multiple antennas of vehicle 102. The transmitter produces electromagnetic waves (i.e., radar signals) in the radio or microwave (for example) domain. The receiver receives the reflected signals that bounce back to vehicle 102 from objects in the scene.

The radar sensor system 104 determines various properties of the reflected signals to help determine objects' locations and speed relative to the vehicle 102. The radar sensor system 104 produces reflective-intensity (RI) data based on that determination. More particularly, the RI data includes a combination of three spectrums of information, which includes range from the radar sensor system 104, speed relative the radar sensor system, and azimuth from the radar sensor system.

The radar sensor system 104 monitors the area or volume around the vehicle 102. Herein, unless the context indicates otherwise, that monitored area or volume is called a scene. For example, as shown in FIG. 1, the scene is the area or volume proximate to the forward direction of the vehicle 102.

The ADAS 222 may be configured to assist drivers of the vehicle 102 in driving or parking functions. In some instances, the ADAS 222 may enable various levels of autonomous driving. Some of the functions that the ADAS 222 may enable or enhance include, for example, adaptive cruise control, automatic parking, autonomous valet parking, navigation, blind spot monitoring, automatic emergency braking, etc. The ADAS 222 may use the object detection results from the object detector module 238 and/or classification from the perception system 224 to perform or assist in the performance of its functionalities.

The perception system 224 may be configured to perform object detection, segmentation, and/or classification. In some instances, the perception system 224 may use the object detection results from the object detector module 238 to indicate a presence of a relevant item that is proximate to the vehicle 102 and/or a classification of the item as an item type (e.g., cyclist, animal, car, pedestrian, building, tree, road surface, curb, sidewalk, unknown, etc.). Additionally, or alternatively, the perception system 224 may indicate one or more characteristics associated with a detected item and/or the environment in which the item is positioned. For example, the characteristics associated with an item may include, but are not limited to, an x-position, a y-position, a z-position, an orientation (e.g., a roll, pitch, yaw), an item type (e.g., a classification), a velocity of the item, an acceleration of the item, an extent of the item (size), etc. Characteristics associated with the environment may include, but are not limited to, a presence of another item in the environment, a state of another item in the environment, a time of day, a day of a week, a season, a weather condition, an indication of darkness/light, etc.

The signal obtainer module 230 may be configured to obtain reflective radar signals regarding a scene monitored by the multiple antennas of the radar sensor system 104. In some implementations, the radar sensor system 104 transmits a sequence of short wavesforms. For example, each waveform may be chirp signal with duration of one-hundred milliseconds (100 ms) and there may be one-hundred twenty-eight of these waveforms that are transmitted consecutively in one radar frame which the RI data is produced and the RIV is generated. For example, one RIV per frame.

The RI data producer module 232 may be configured to produce RI data based on the reflective radar signals, which were obtained by the signal obtainer module 230. The produced RI data contains multiple spatially invariant spectrums of measurements and/or information.

Those spatially invariant spectrums may be derived from one or more radar signals reflected to the radar sensor system 104 and received thereby. The radar signal was reflected by something in the scene of monitored by the radar sensor system 104. The produced data indicate the reflection intensity of the reflected radar signals across the range, the Doppler, and the adjusted-azimuth spectrums. In addition, the produced data may include information about the signals received by several of the multiple antennas of the antenna array of the radar sensor system 104, the relative position of those antennas, and the wavelength of the radar signal.

The spatially invariant spectrums of the reflective-intensity data include the range reflective-intensity spectrum that includes relative distances between reflection points indicated by the RI data and the radar sensor system 104; the Doppler reflective-intensity spectrum that includes velocities of the reflection points indicated by the reflective-intensity data relative to the radar sensor system; and the adjusted azimuth (“adjusted-azimuth”) spectrum, which is based on azimuths of the reflection points indicated by the reflective-intensity data relative to the radar sensor system.

The RI data producer module 232 may be configured to determine a two-dimensional range-Doppler transform that incorporates (i.e., produces) the range reflective-intensity spectrum and Doppler reflective-intensity spectrum. In some implementations, the RI data producer module 232 may make this determination by transforming the range reflective-intensity spectrum by the reflective radar signals, wherein the range reflective-intensity spectrum includes range bins based on the reflective radar signals by multiple antennas of the radar sensor system. In some instances, the RI data producer 232 may apply a fast Fourier transform (FFT) per each short duration waveform (e.g., per each chirp signal) and per each antenna of the multiple antennas. The result includes range bins per each antenna and per each short duration waveform (e.g., 100 ms).

In some implementations, the RI data producer module 232 may make this determination by transforming the Doppler reflective-intensity spectrum by the reflective radar signals, wherein the Doppler reflective-intensity spectrum includes Doppler bins based on the range bins and the reflective radar signals by multiple antennas of the radar sensor system. In some instances, the RI data producer 232 may apply a second FFT per each range bin and each antenna. That is, the FFT is applied per each range bin and antenna. Thus, this results in a sequence of bins along the waveforms sequence (for example, one-hundred twenty-eight sequence). The RI data producer 232 may apply the FFT to this sequence to obtain the Doppler bins of each range bin.

In some implementations, the RI data producer module 232 may perform at two-dimensional FFT over a short duration of waveforms and a long duration of waveforms. In this respect, the RI data producer module 232 produces this two-dimensional FFT processes in the range-Doppler reflection intensity spectrum of each antenna.

In addition, the RI data producer module 232 may be configured to determine the adjusted-azimuth spectrum by calculating sine of the azimuth (“sin(azimuth)”) relative to a two-dimensional range-Doppler transform that incorporates the range reflective-intensity spectrum and Doppler reflective-intensity spectrum. For example, the RI data producer module 232 may be configured to determine the adjusted-azimuth spectrum by calculating sin(azimuth) of the two-dimensional range-Doppler transform. In some instances, the RI data producer module 232 may be configured to determine the adjusted-azimuth spectrum by calculating the reflection intensity in sin(azimuth) for each range-Doppler bin.

With the typical approach to producing RI data, the azimuth spectrum is utilized and it is spatially variant. That is, the peaks in reflection intensity at different azimuths have differing spreading functions. Herein, the RI data producer produces the adjusted-azimuth spectrum that, unlike the typical approach, is spatially variant. That is, the peaks in reflection intensity at different adjusted-azimuths have matching spreading functions. Herein, unless the context indicates otherwise, references to peaks include their accompanying spreading functions.

The RIV generator module 234 may be configured to generate a reflective intensity volume (RIV) based on the RI data produced by the RI data producer module 232. RIV generator module 234 generates the RIV in a manner so that the results are spatially invariant.

The RIV generator module 234 may be configured to combine the results of the calculating for the range bins and Doppler to produce a three-dimensional, spatially invariant range-speed-adjusted-azimuth transform. In some instances, the RIV generator module 234 may be configured to combine the range-Doppler bins along the antennas.

For example, the generation operation may be described mathematically, in part, in accordance with Equation 1 below. This is a calculation of the reflection intensity in the sin(azimuth) domain. This calculation is performed per each range-Doppler bin across the transmit and receive antennas.

$$\\ \begin{matrix}P ( z ) = {\sum }_{n = 0}^{N - 1} {x}_{n} {e}^{{}_{} \frac{{}_{} j 2 π {d}_{{nz}_{}}}{λ}} , & Equation 1\end{matrix}$$

wherein:
P(z) is the reflection intensity at z=sin(azimuth) for a range-Doppler bin;
n is cardinality of the multiple antennas;
xₙ is a received radar signal at an n-th antenna;
dₙ is the relative distance of an n-th antenna with respect to an antenna (e.g., a first) in the antenna array;
λ is the defined wavelength of the radar signal;
j represents an imaginary number;
π is value of pi; and
e is an exponential function, for example it may be Euler's number, mathematical constant approximately equal to 2.71828.

In some instances, xₙ is some range-Doppler bin of the n-th antenna. The RIV generator module 234 may be configured to calculate P(z) for each range-Doppler bin, and therefore xₙ is for one of the range-Doppler bins.

The RIV generator module 234 outputs a three-dimensional cube of reflection intensity in range-Doppler bins along the adjusted-azimuth domain. In so doing, the spreading function that is associated with each reflection point is the same regardless of the reflection point position (e.g., azimuth).

The CNN applier module 236 may be configured to apply the trained CNN engine 240 on the generated RIV. More particularly, the CNN is applied to the spatially invariant range-Doppler-adjusted-azimuth transform, which is the result of the calculation performed by the RIV generator module 234. The application of the trained CNN may include producing a fully connected layer of object detection candidates based on the spatially invariant range-Doppler-adjusted-azimuth transform. The produces a fully connected neural network that output object detection candidates.

The CNN applier module 236 may be configured to reverse the sin(azimuth) transform by applying the inverse sine operation to convert results back to the azimuth spectrum. The parameters of the object detection candidates are the range-Doppler-adjusted-azimuth domains. However, to be useful for object detection purposes, the candidates should be described in the range-Doppler-azimuth domains. The CNN applier module 236 may be configured to convert the parameters from the sin(azimuth) spectrum to the azimuth spectrum. In some instances, the CNN applier module 236 may be configured to convert the three-dimensional, spatially invariant range-speed-adjusted-azimuth transform into a three-dimensional, spatially variant range-speed-azimuth transform by performing inverse sine operation in the azimuth spectrum.

The object detector module 238 may be configured to analyze the object detection candidates produced by the CNN applier module 236 to report on detected objects to, for example, the perception system 224 of the vehicle 102. In addition, the object detector module 238 may be configured to classify the detected objects in the scene. The object detector module 238 may classify detected object into an item type, such as a cyclist, animal, car, pedestrian, building, tree, road surface, curb, sidewalk, unknown, and the like. In some instances, the perception system 224 may perform or assist in the performance of object classification.

The CNN engine 240 is the trained CNN model that is applied by the CNN applier module 236 on the three-dimensional, spatially invariant range-Doppler-adjusted-azimuth transform based on the reflective-intensity data. The CNN engine 240 is iteratively trained to detect objects using the techniques described herein with detection learning/improvement being based on ground truth high-resolution reflection maps. The ground truth map is a labeled dataset with the targets for training and validating the model of the CNN engine 240.

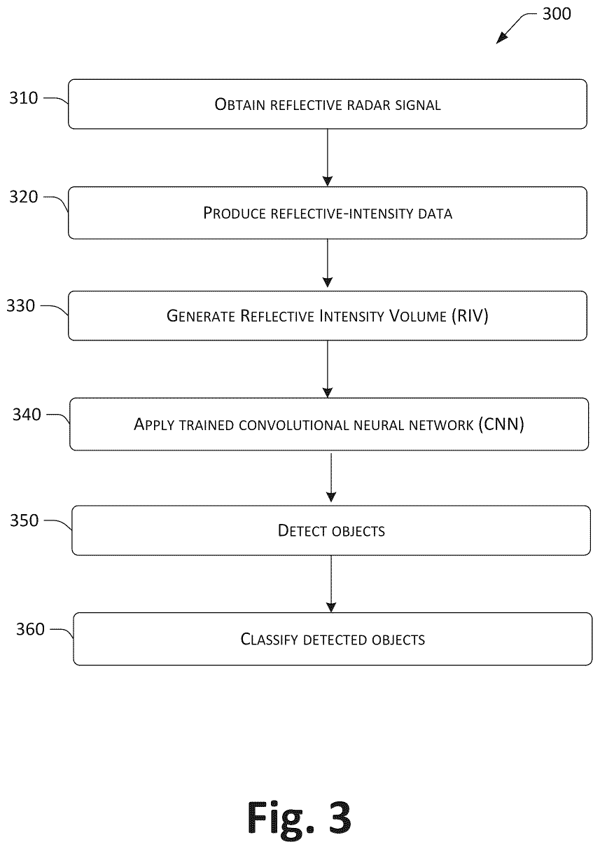

FIG. 3 is a flowchart illustrating process 300 to perform an example method that facilitates object detection. For ease of illustration, process 300 may be described as being performed by a device or system described herein, such as vehicle 102 or the computing system 200. However, process 300 may be performed by other devices or a combination of devices and systems.

At operation 310, the system obtains reflective radar signals regarding a scene monitored by the multiple antennas of the radar sensor system 104. In some implementations, the radar sensor system 104 transmits a sequence of short wavesforms. For example, each waveform may be chirp signal with duration of one-hundred milliseconds (100 ms) and there may be one-hundred twenty-eight of these waveforms that are transmitted consecutively in one radar frame which the RI data is produced and the RIV is generated. For example, one RIV per frame.

At operation 320, the system produces reflective-intensity (RI) data based on the reflective radar signals, which were obtained by operation 310. The produced RI data contains multiple spatially invariant spectrums of measurements and/or information, to determine a two-dimensional range-Doppler transform that incorporates the range reflective-intensity spectrum and Doppler reflective-intensity spectrum. In some implementations, the production of the RI data includes a determination by transforming the range reflective-intensity spectrum by the reflective radar signals, wherein the range reflective-intensity spectrum includes range bins based on the reflective radar signals by multiple antennas of the radar sensor system. In some instances, this transformation may involve an application of a fast Fourier transform (FFT) per each short-duration waveform (e.g., per each chirp signal) and per each antenna of the multiple antennas. The result includes range bins per each antenna and per each short-duration waveform (e.g., 100 ms).

In some implementations, the production of the RI data includes a determination by transforming the Doppler reflective-intensity spectrum by the reflective radar signals, wherein the Doppler reflective-intensity spectrum includes Doppler bins based on the range bins and the reflective radar signals by multiple antennas of the radar sensor system. In some instances, this transformation may involve an application a second FFT per each range bin and each antenna. That is, the FFT is applied per each range bin and antenna. Thus, this results in a sequence of bins along the waveforms sequence (for example, one-hundred twenty-eight sequence). The production operation 320 may apply the FFT to this sequence to obtain the Doppler bins of each range bin.

In some implementations, the production operation 320 may perform at two-dimensional FFT over the short duration of waveforms and the long duration of waveforms. In this respect, the production operation 320 produces this two-dimensional FFT processes in the range-Doppler reflection intensity spectrum of each antenna.

In addition, the production operation 320 may be configured to determine the adjusted-azimuth spectrum by calculating sine of the azimuth (“sin(azimuth)”) relative to a two-dimensional range-Doppler transform that incorporates the range reflective-intensity spectrum and Doppler reflective-intensity spectrum.

With the typical approach to producing RI data, the azimuth spectrum is utilized and it is spatially variant. That is, the peaks in reflection intensity at different azimuths have differing spreading functions. Herein, the RI data producer produces the adjusted-azimuth spectrum that, unlike the typical approach, is spatially variant. That is, the peaks in reflection intensity at different adjusted-azimuths have matching spreading functions. Herein, unless the context indicates otherwise, references to peaks include their accompanying spreading functions.

At operation 330, the system generates RIV based on the RI data produced by the production operation 320. Operation 330 generates the RIV in a manner so that the results are spatially invariant.

The operation 330 may combine the results of the calculating for the range bins and Doppler to produce a three-dimensional, spatially invariant range-speed-adjusted-azimuth transform. In some instances, the operation 330 may combine the range-Doppler bins along the antennas. For example, the generation operation may be described mathematically, in part, in accordance with Equation 1 herein.

The operation 330 may output a three-dimensional cube of reflection intensity in range-Doppler bins along the adjusted-azimuth domain. In so doing, the spreading function that is associated with each reflection point is the same regardless of the reflection point position (e.g., azimuth).

At operation 340, the system applies a trained CNN on the generated RIV. More particularly, the CNN is applied to the spatially invariant range-Doppler-adjusted-azimuth transform, which is the result of the calculation performed by the operation 330. The application of the trained CNN may include producing a fully connected layer of object detection candidates based on the spatially invariant range-Doppler-adjusted-azimuth transform.

The operation 340 may reverse the sin(azimuth) transform by applying the inverse sine operation to convert results back to the azimuth spectrum. The parameters of the object detection candidates are the range-Doppler-adjusted-azimuth domains. However, to be useful for object detection purposes, the candidates should be described in the range-Doppler-azimuth domains. The operation 340 may convert the parameters from the sin(azimuth) spectrum to the azimuth spectrum. In some instances, the operation 340 may convert the three-dimensional, spatially invariant range-speed-adjusted-azimuth transform into a three-dimensional, spatially variant range-speed-azimuth transform by performing inverse sine operation in the azimuth spectrum.

At operation 350, the system analyzes the object detection candidates produced by the application of the CNN model. Based on this analysis, the system reports on detected objects to, for example, the perception system 224 of the vehicle 102.

At operation 360, the system classifies the detected objects in the scene.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels and are not intended to impose numerical or positional requirements on their objects. As used herein, an element or step recited in the singular and preceded by the word “a” or “an” should be understood as not excluding the plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51% to 99% out of a possible extent of 100%”, and do not necessarily mean “perfectly”, “completely”, “strictly”, “entirely” or “100%”. Additionally, the word “proximate” may be used herein to describe the location of an object or portion thereof concerning another object or portion thereof, and/or to describe the positional relationship of two objects or their respective portions thereof concerning each other, and may mean “near”, “adjacent”, “close to”, “close by”, “at” or the like. And, the phrase “approximately equal to” as used herein may mean one or more of “exactly equal to”, “nearly equal to”, “equal to somewhere between 90% and 110% of” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method that facilitates object detection, the method comprising:
obtaining reflective radar signals regarding a scene monitored, the reflective radar signals being received by multiple antennas of a radar sensor system;
producing reflective-intensity data based on the reflective radar signals, the reflective-intensity data containing multiple spatially invariant spectrums;
generating a reflective intensity volume (RIV) based on the reflective-intensity data;
applying a trained convolutional neural network (CNN) on the generated RIV; and
detecting objects in the scene based, at least in part, the applying of the trained CNN on the generated RIV.

2. A method of claim 1 further comprising:
reporting detected objects to a perception system of a vehicle; and
classifying the detected objects in the scene.

3. A method of claim 1, wherein the spatially invariant spectrums of the reflective-intensity data include 1) a range reflective-intensity spectrum includes relative distances between reflection points indicated by the reflective-intensity data and the radar sensor system, 2) a speed (“Doppler”) reflective-intensity spectrum includes speeds of the reflection points indicated by the reflective-intensity data relative to the radar sensor system, and 3) an adjusted azimuth (“adjusted-azimuth”) spectrum, which is based on azimuths of the reflection points indicated by the reflective-intensity data relative to the radar sensor system.

4. A method of claim 3, wherein the producing reflective-intensity data includes determining a two-dimensional range-Doppler transform that incorporates the range reflective-intensity spectrum and Doppler reflective-intensity spectrum.

5. A method of claim 4, wherein the determining the two-dimensional range-Doppler transform includes:
transforming the range reflective-intensity spectrum by the reflective radar signals, wherein the range reflective-intensity spectrum includes range bins based on the reflective radar signals by multiple antennas of the radar sensor system; and
transforming the Doppler reflective-intensity spectrum by the reflective radar signals, wherein the Doppler reflective-intensity spectrum includes Doppler bins based on the range bins and the reflective radar signals by multiple antennas of the radar sensor system.

6. A method of claim 3, wherein the producing reflective-intensity data includes determining the adjusted-azimuth spectrum by calculating sine of the azimuth (“sin(azimuth)”) relative to a two-dimensional range-Doppler transform that incorporates the range reflective-intensity spectrum and Doppler reflective-intensity spectrum.

7. A method of claim 5, wherein:
the producing reflective-intensity data includes determining the adjusted-azimuth spectrum by calculating sine of the azimuth (“sin(azimuth)”) relative to the range bins and Doppler bins of the two-dimensional range-Doppler transform; and
the generating includes combining results of the calculating for the range bins and Doppler to produce a three-dimensional, spatially invariant range-speed-adjusted-azimuth transform.

8. A method of claim 7, wherein each antenna of the multiple antennas having has a distance relative to other antennas of the multiple antennas and employing a radar signal having a defined wavelength, and the calculating of the adjusted-azimuth spectrum includes performing:
$$\\ P ( z ) = {\sum }_{n = 0}^{N - 1} {x}_{n} {e}^{{}_{} \frac{{}_{} j 2 π {d}_{{nz}_{}}}{λ}} ,$$
wherein:
The RIV is based on P(z), which is the reflection intensity at z=sin(azimuth);
n is cardinality of the multiple antennas;
xₙ is a received radar signal at an n-th antenna;
dₙ is the relative distance of an n-th antenna with respect to an antenna of the mulitple antennas;
λ is the defined wavelength of the radar signal;
j represents an imaginary number;
π is value of pi; and
e is an exponential function.

9. A method of claim 7, wherein the applying includes converting the three-dimensional, spatially invariant range-speed-adjusted-azimuth transform into a three-dimensional, spatially variant range-speed-azimuth transform by performing inverse sine operation in the azimuth spectrum.

10. A method of claim 7, wherein the RIV includes reflection points and has matching spreading functions associated with each reflection point.

11. A device selected from a group consisting of an autonomous vehicle, a semi-autonomous vehicle, a video surveillance system, a medical imaging system, a video or image editing system, an object tracking system, a video or image search or retrieval system, and a weather forecasting system, the device being configured to perform the method of claim 1.

12. A method comprising:
obtaining reflective radar signals regarding a scene monitored, the reflective radar signals being received by multiple antennas of a radar sensor system;
producing reflective-intensity data based on the reflective radar signals, the reflective-intensity data containing multiple spatially invariant spectrums, which include 1) a range reflective-intensity spectrum includes relative distances between reflection points indicated by the reflective-intensity data and the radar sensor system, 2) a speed (“Doppler”) reflective-intensity spectrum includes speeds of the reflection points indicated by the reflective-intensity data relative to the radar sensor system, and 3) an adjusted azimuth (“adjusted-azimuth”) spectrum, which is based on azimuths of the reflection points indicated by the reflective-intensity data relative to the radar sensor system, and wherein the producing includes determining a two-dimensional range-Doppler transform that incorporates the range reflective-intensity spectrum and Doppler reflective-intensity spectrum;
generating a reflective intensity volume (RIV) based on the reflective-intensity data;
applying a trained convolutional neural network (CNN) on the generated RIV; and
detecting objects in the scene based, at least in part, the applying of the trained CNN on the generated RIV.

13. A method of claim 12, wherein the determining the two-dimensional range-Doppler transform includes:
transforming the range reflective-intensity spectrum by the reflective radar signals, wherein the range reflective-intensity spectrum includes range bins based on the reflective radar signals by multiple antennas of the radar sensor system; and
transforming the Doppler reflective-intensity spectrum by the reflective radar signals, wherein the Doppler reflective-intensity spectrum includes Doppler bins based on the range bins and the reflective radar signals by multiple antennas of the radar sensor system.

14. A method of claim 13, wherein the producing reflective-intensity data includes determining the adjusted-azimuth spectrum by calculating sine of the azimuth (“sin(azimuth)”) relative to a two-dimensional range-Doppler transform that incorporates the range reflective-intensity spectrum and Doppler reflective-intensity spectrum.

15. A method of claim 14, wherein:
the producing reflective-intensity data includes determining the adjusted-azimuth spectrum by calculating sine of the azimuth (“sin(azimuth)”) relative to the range bins and Doppler bins of the two-dimensional range-Doppler transform; and
the generating includes combining results of the calculating for the range bins and Doppler to produce a three-dimensional, spatially invariant range-speed-adjusted-azimuth transform.

16. A method of claim 15, wherein the applying converting the three-dimensional, spatially invariant range-speed-adjusted-azimuth transform into a three-dimensional, spatially variant range-speed-azimuth transform by performing inverse sine operation in the azimuth spectrum.

17. A non-transitory machine-readable storage medium encoded with instructions executable by one or more processors that, when executed, direct the one or more processors to perform operations that facilitate object detection, the operations comprising:
obtaining reflective radar signals regarding a scene monitored, the reflective radar signals being received by multiple antennas of a radar sensor system;
producing reflective-intensity data based on the reflective radar signals, the reflective-intensity data containing multiple spatially invariant spectrums, which include 1) a range reflective-intensity spectrum includes relative distances between reflection points indicated by the reflective-intensity data and the radar sensor system, 2) a speed (“Doppler”) reflective-intensity spectrum includes speeds of the reflection points indicated by the reflective-intensity data relative to the radar sensor system, and 3) an adjusted azimuth (“adjusted-azimuth”) spectrum, which is based on azimuths of the reflection points indicated by the reflective-intensity data relative to the radar sensor system, and wherein the producing includes determining a two-dimensional range-Doppler transform that incorporates the range reflective-intensity spectrum and Doppler reflective-intensity spectrum;
generating a reflective intensity volume (RIV) based on the reflective-intensity data;
applying a trained convolutional neural network (CNN) on the generated RIV; and
detecting objects in the scene based, at least in part, the applying of the trained CNN on the generated RIV.

18. A non-transitory machine-readable storage medium of claim 17, wherein the determining the two-dimensional range-Doppler transform includes:
transforming the range reflective-intensity spectrum by the reflective radar signals, wherein the range reflective-intensity spectrum includes range bins based on the reflective radar signals by multiple antennas of the radar sensor system; and
transforming the Doppler reflective-intensity spectrum by the reflective radar signals, wherein the Doppler reflective-intensity spectrum includes Doppler bins based on the range bins and the reflective radar signals by multiple antennas of the radar sensor system.

19. A non-transitory machine-readable storage medium of claim 18, wherein the producing reflective-intensity data includes determining the adjusted-azimuth spectrum by calculating sine of the azimuth (“sin(azimuth)”) relative to a two-dimensional range-Doppler transform that incorporates the range reflective-intensity spectrum and Doppler reflective-intensity spectrum.

20. A non-transitory machine-readable storage medium of claim 19, wherein:
the producing reflective-intensity data includes determining the adjusted-azimuth spectrum by calculating sine of the azimuth (“sin(azimuth)”) relative to the range bins and Doppler bins of the two-dimensional range-Doppler transform; and
the generating includes combining results of the calculating for the range bins and Doppler to produce a three-dimensional, spatially invariant range-speed-adjusted-azimuth transform.
